(19) United States
(12) Patent Application Publication
(10) Pub. No.: US 2023/0143033 A1
(43) Pub. Date: May 11, 2023

(54) Method for Vehicle Rental, Electronic Device, and Computer Storage Medium

(71) Applicant: Shanghai Qwik Smart Technology Co., Ltd., Xuhui District, Shanghai (CN)

(72) Inventors: Hongren Shi, Shanghai (CN); Yanan Song, Shanghai (CN)

(21) Appl. No.: 17/801,155

(22) PCT Filed: Dec. 31, 2020
(86) PCT No.: PCT/CN2020/142054

§ 371 Date: Jan. 26, 2023

(30) Foreign Application Priority Data
Feb. 20, 2020 (CN) 202010105951.0

(51) Int. Cl. G06Q 30/0645; G06Q 50/30; G06Q 10/02; G06Q 30/0283; H04L 9/40; G05D 1/00

(52) U.S. Cl. CPC G06Q 30/0645; G06Q 50/30; G06Q 10/02; G06Q 30/0284; H04L 63/062; G05D 1/0011; G05D 2201/0212; G05D 2201/0213

(57) ABSTRACT

A method for vehicle rental, an electronic device, and a computer storage medium are provided. The method includes the following. A vehicle rental request is received, wherein the vehicle rental request is at least indicative of a pickup location and a rental time of a user. Whether there exists a vehicle to-be-rented matched with the vehicle rental request at a rental outlet is determined in response to determining that there is no vehicle to-be-rented matched with the vehicle rental request at the pickup location, wherein the rental outlet is pre-selected by a user or determined based on a predetermined range from the pickup location. The vehicle to-be-rented at the rental outlet is determined as a rented vehicle in response to determining that there is the vehicle to-be-rented at the rental outlet. A task of vehicle delivery is sent to an electronic device associated with the rental outlet.

### CROSS-REFERENCE TO RELATED APPLICATION(S)

This application claims priority to International Application No. PCT/CN2020/142054, filed on Dec. 31, 2020, which claims priority to Chinese Patent Application No. 202010105951.0, filed Feb. 20, 2020, entitled “method for vehicle rental, electronic device, and computer storage medium”, the entire disclosure of which is hereby incorporated by reference.

### TECHNICAL FIELD

This disclosure relates to the field of vehicle management, and in particular to a method for vehicle rental, an electronic device, and a computer storage medium.

### BACKGROUND

A traditional method for vehicle rental is for example as follows. When renting a vehicle, users book the vehicle of a rental platform via the rental platform, then go to a rental outlet of the rental platform on their own and contact with a vehicle manager of a rental company who assigns a vehicle key, therefore implementing control of the vehicle. When returning the vehicle, the user needs to park the vehicle at the rental outlet of the rental platform and returns the vehicle key to the vehicle manager of the rental company before vehicle return is completed.

In the above traditional method for vehicle rental, the user needs to consume much time to choose the rental outlet, choose the vehicle, go to the rental outlet to pick up the vehicle, take the vehicle key, drop off the vehicle, return the vehicle key, etc., and both vehicle pickup and vehicle drop-off require the user to drive the vehicle to a designated rental outlet, which is very inconvenient. Especially when there are few designated rental outlets or the user lives far from the designated rental outlet, it will cause difficulties for the user.

Therefore, the traditional solution of renting a vehicle has the shortcomings of consuming a lot of time and energy of the user, as well as not enabling the user to determine a pickup location.

### SUMMARY

The disclosure provides a method for vehicle rental, an electronic device, and a computer storage medium, to save the time and effort of a user in renting a vehicle and allow the user to determine where to pick up the vehicle.

According to a first aspect, a method for vehicle rental is provided. The method includes the following. A vehicle rental request is received, which is at least indicative of a pickup location and a rental time of a user. Whether there exists a vehicle to-be-rented matched with the vehicle rental request at a rental outlet is determined in response to determining that there is no vehicle to-be-rented matched with the vehicle rental request at the pickup location, where the rental outlet is pre-selected by the user or determined based on a predetermined range from the pickup location. The vehicle to-be-rented at the rental outlet is determined as a rented vehicle in response to determining that there is the vehicle to-be-rented at the rental outlet. A task of vehicle delivery is sent to an electronic device associated with the rental outlet, where the task is indicative of a location of the rented vehicle, the pickup location and the rental time, such that the rented vehicle in a ready state can be driven by an associated user of the electronic device to the pickup location.

According to a second aspect, a method for vehicle rental is provided. The method includes the following. At an electronic device, a task of at least one of vehicle delivery and vehicle equipment is obtained, which is indicative of a current location of a rented vehicle, a state of the rented vehicle, a pickup location, and information of a user renting the vehicle. A correlation between the current location of the rented vehicle and a rental outlet associated with the electronic device is determined. Whether the state of the rented vehicle is a ready state is determined. A request for a route to the pickup location is sent, which is used for an associated user of the electronic device to drive the rented vehicle in the ready state to the pickup location. A message indicating that the rented vehicle has arrived is sent to the user in response to determining that the rented vehicle arrives at the pickup location.

According to a third aspect, an electronic device is provided. The electronic device includes a memory and a processor. The memory is configured to store one or more computer programs. The processor is coupled with the memory and is configured to execute the one or more programs to cause the device to perform the method of the first aspect of the disclosure.

According to a fourth aspect, a non-transitory computer-readable storage medium is provided. The non-transitory computer-readable storage medium stores a machine-executable instruction thereon, which when executed, causes a machine to perform the method of the first aspect of the disclosure.

The summary is provided to introduce concepts of the disclosure in a simplified form, which will be further described in the following detailed description. The summary does not intend to identify key features or essential features of the present disclosure, nor does it intend to limit the scope of the present disclosure.

### BRIEF DESCRIPTION OF THE DRAWINGS

FIG. 1 is a schematic diagram illustrating a system 100 of a method for vehicle rental according to implementations of the disclosure.

FIG. 2 is a schematic flow chart illustrating a method 200 for vehicle rental according to implementations of the disclosure.

FIG. 3 is a schematic flow chart illustrating a method 300 for sharing a virtual key of a rented vehicle according to implementations of the disclosure.

FIG. 4 is a schematic flow chart illustrating a method 400 for vehicle return according to implementations of the disclosure.

FIG. 5 is a schematic flow chart illustrating a method 500 for vehicle rental according to implementations of the disclosure.

FIG. 6 is a schematic flow chart illustrating a method 600 for vehicle pickup according to implementations of the disclosure.

FIG. 7 is a schematic flow chart illustrating a method 700 for vehicle pickup according to implementations of the disclosure.

FIG. 8 is a schematic block diagram illustrating an electronic device 800 suitable for implementing the implementations of the disclosure.

In each of the accompanying drawings, the same or corresponding numerals represent the same or corresponding parts.

### DETAILED DESCRIPTION

Various implementations of the present disclosure will be described in more details with reference to the drawings. Although the drawings illustrate the implementations of the present disclosure, it should be appreciated that the present disclosure can be implemented in various manners and should not be limited to the implementations explained herein. On the contrary, the implementations are provided to make the present disclosure more thorough and complete and to fully convey the scope of the present disclosure to those skilled in the art.

As used herein, the term “include” and its variants are to be read as open-ended terms that mean “include, but is not limited to.” The term “or” is to be read as “and/or” unless the context clearly indicates otherwise. The term “based on” is to be read as “at least based on in part.” The terms “one example implementation” and “one implementation” are to be read as “at least one example implementation.” The term “a further implementation” is to be read as “at least a further implementation.” The terms “first”, “second” and so on can refer to same or different objects. The following text also can include other explicit and implicit definitions.

As mentioned above, in the above traditional method for vehicle rental, users need to consume much time to choose the rental outlet, choose the vehicle, go to the rental outlet to pick up the vehicle, take the vehicle key, drop off the vehicle, return the vehicle key, etc., and both vehicle pickup and vehicle drop-off need to drive the vehicle to the designated rental outlet, which is very inconvenient. Therefore, the traditional solution of renting a vehicle has the shortcomings of consuming a lot of time and energy of the user, as well as not enabling the user to determine the pickup location.

To solve at least in part the foregoing problem and one or more of other potential problems, a method for vehicle rental is provided according to implementations of the disclosure. The method includes the following. A vehicle rental request is received, which is at least indicative of a pickup location and a rental time of a user. Whether there exists a vehicle to-be-rented matched with the vehicle rental request at a rental outlet is determined in response to determining that there is no vehicle to-be-rented matched with the vehicle rental request at the pickup location, where the rental outlet is pre-selected by the user or determined based on a predetermined range from the pickup location. The vehicle to-be-rented at the rental outlet is determined as a rented vehicle in response to determining that there is the vehicle to-be-rented at the rental outlet. A task of vehicle delivery is sent to an electronic device associated with the rental outlet, where the task is indicative of a location of the rented vehicle, the pickup location and the rental time, such that the rented vehicle in the ready state can be driven by an associated user of the electronic device to the pickup location.

As mentioned above, the task of vehicle delivery indicating the pickup location and the location of the rented vehicle is sent to the electronic device associated with the rental outlet, when determining that there is no vehicle to-be-rented matched with the vehicle rental request at the pickup location indicated in the vehicle rental request of the user but the near rental outlet exists the vehicle to-be-rented matched with the vehicle rental request, such that the rented vehicle in the ready state can be driven by the associated user of the electronic device to the pickup location. In the disclosure, the time and energy of the user in vehicle renting can be saved and the user can determine the pickup location.

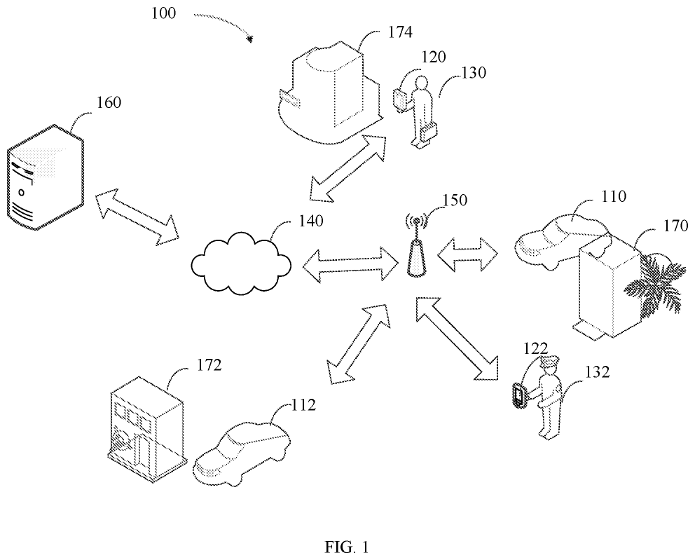

FIG. 1 is a schematic diagram illustrating a system 100 of a method for vehicle rental according to implementations of the disclosure. As illustrated in FIG. 1, the system 100 includes a vehicle 110, a vehicle 112, a user equipment 120 of a user 130 (such as a user of renting a vehicle), a server 160, an electronic device 122 of an associated user 132 (such as a vehicle manager associated with a rental outlet 170), the rental outlet 170, a building 172, and a building 174. In some examples, the vehicle 110 and the vehicle 112, the user equipment 120, the electronic device 122, and the server 160, for example, may be configured to perform data interaction via a base station 150, a network 140, and the like. The vehicle 110 and the vehicle 112 also may be configured to perform data interaction and sharing with the user equipment 120 or the electronic device 122 each owning a virtual key via wireless communication methods such as wireless fidelity (Wi-Fi), Bluetooth, cellular, and near field communication (NFC).

The vehicle 110, for example, includes at least an in-vehicle computing device (such as a video audio entertainment system (VAES)), an in-vehicle data sensing device, a communication module (such as an in-vehicle telematics BOX (T-BOX)), and a global positioning system (GPS) module. The in-vehicle data sensing device includes at least a fuel volume sensor. Based on the virtual key, the vehicle 110 may be configured to perform data interaction and sharing with the user equipment 120 and the electronic device 122, which establish association with the vehicle 110, via the wireless communication methods such as the Wi-Fi, the Bluetooth, the cellular, and the NFC. For example, the user equipment 120 can establish an association with the vehicle 110 when a predetermined action (such as shaking) of the user equipment 120 is detected.

The communication module, such as the in-vehicle T-BOX, may be configured to perform data interaction with the in-vehicle computing device (such as the VAES), the user equipment 120, the electronic device 122, and the server 160. In some examples, the in-vehicle T-BOX includes, for example, a subscriber identity module (SIM) card, a GPS antenna, a 4th generation (4G) antenna, or a 5th generation (5G) antenna. When an application (APP) of the user equipment 120 or of the electronic device 122 (such as a mobile phone) sends a token and a control command (such as remotely starting the vehicle, opening an air conditioning of the vehicle, adjusting a seat to a suitable location), a telematics service provider (TSP) will send in background a monitoring request instruction to the in-vehicle T-BOX. After the vehicle obtains the control command, it sends a control packet and implements control of the vehicle via a controller area network (CAN) bus, and finally feeds back an operation result to the APP of the user equipment 120 or of the electronic device 122. The in-vehicle T-BOX and the VAES communicate via the CAN bus to implement data interaction, such as transmitting state information of the vehicle, button state information, a control instruction. The in-vehicle T-BOX may collect bus data related to a bus of the vehicle 110 such as a diagnose CAN (DCAN), a kommunikation CAN (KCAN), and a power train CAN (PTCAN).

The user equipment 120 is configured to send a vehicle rental request, which is, but not limited to, a mobile phone. After establishing the connection with the rented vehicle based on the Bluetooth key, the user equipment 120 may directly perform data interaction with the in-vehicle T-BOX, or may perform data interaction with the server 160 and the electronic device 122 via the base station 150 and the network 140. In some examples, the user equipment 120 may be a tablet computer, a mobile phone, a wearable device, and the like.

The electronic device 122 is configured to receive tasks of vehicle delivery, vehicle equipment, and vehicle return, and send a request to a server and receive a virtual key of the rented vehicle, a route to a pickup location, a return location, or a current location of the rented vehicle, and the like. The task of vehicle equipment refers to equipping the vehicle to get the vehicle into a ready state. For example, components of the vehicle such as start/brake devices, doors and windows, lights, tires, etc. are ensured to work normally, enough energy (such as electricity or fuel), engine oil, coolant, etc. are filled into the vehicle, the vehicle is kept clean and tidy, some bottled water and tissue are prepared, and the like. The electronic device 122 may be, for example, but not limited to, a mobile phone. After establishing the connection with the rented vehicle based on the Bluetooth key, the electronic device 122 may directly perform data interaction with the in-vehicle T-BOX, or may perform data interaction with the server 160 and the electronic device 120 via the base station 150 and the network 140. In some examples, the user equipment 120 may be a tablet computer, a mobile phone, a wearable device, and the like.

The server 160 is configured to provide a service of vehicle rental of a rental platform. The server 160 is configured to receive the vehicle rental request and a vehicle return request of a user, determine the rented vehicle, generate tasks of vehicle delivery, vehicle equipment, and vehicle pickup, and send information of a route to the pickup location, the return location, and the current location of the rented vehicle, and the like. In some examples, the server 160 is further configured to share the virtual key of the rented vehicle. The server 160 may be configured to perform data interaction with the vehicle 110, the vehicle 112, the user equipment 120, and the electronic device 122 via, for example, the network 140 and the base station 150. In some examples, the server 160 may have one or more processing units, including dedicated processing units such as a graphics processing unit (GPU), a field-programmable gate array (FPGA), and an application specific integrated circuit (ASIC), and a general-purpose processing unit such as a central processing unit (CPU). In addition, one or more virtual machines may also be running on each computing device.

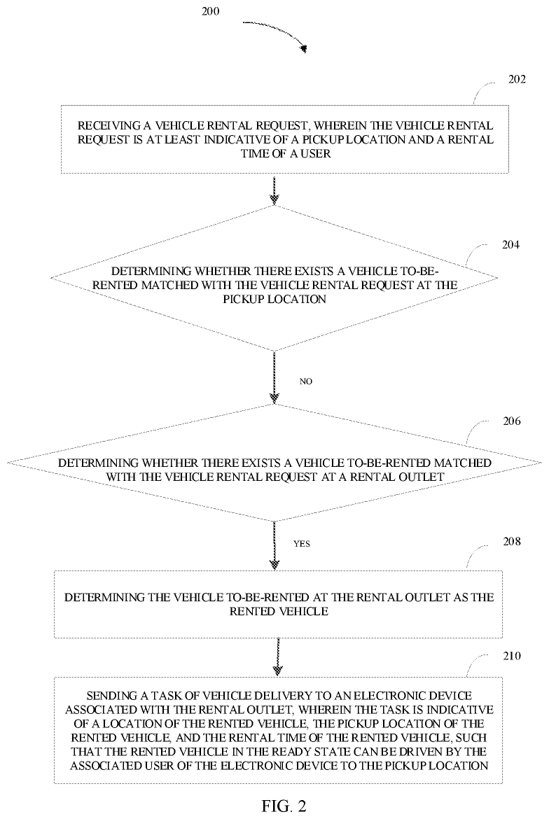

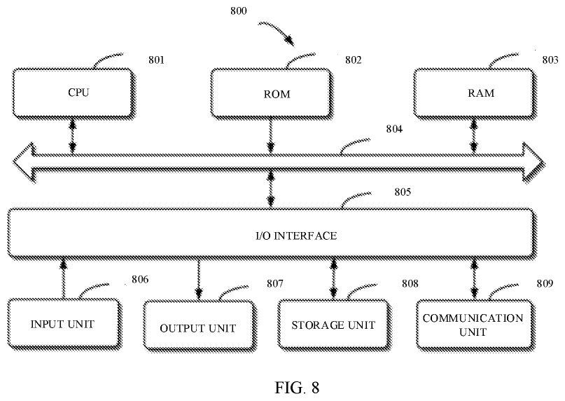

In the following, methods for vehicle rental according to implementations of the disclosure will be described in conjunction with FIG. 2 to FIG. 7. FIG. 2 is a schematic flow chart illustrating a method 200 for vehicle rental according to implementations of the disclosure. It should be understood that the method 200 for example may be performed by the electronic device 800 as shown in FIG. 8 or the server 160 as shown in FIG. 1. It should be understood that the method 200 may further include additional operations not shown and/or may omit operations shown, and the disclosure is not limited thereto.

At block 202, a server 160 receives a vehicle rental request, which is indicative of at least a pickup location and a rental time of a user 130. In some implementations, the vehicle rental request is further indicative of a vehicle type. The vehicle type may be predetermined by the user 130 or determined based on historical rental information of the user 130.

The pickup location, in some examples, may be determined based on a location of a user equipment 120 of the user 130. For example, the user equipment 120 obtains a current location of the user equipment 120 by invoking an underlying application programming interface (API) of an operating system via an APP and determines the obtained current location of the user equipment 120 as the pickup location included in the vehicle rental request. In some examples, the user equipment 120 may integrate a map engine through the APP and determine the pickup location based on a selection of the user against a map. Therefore, the user may conveniently determine the pickup location. For example, a determined pickup location by the user is a parking lot of a building 174.

The rental time, for example, is determined by the user equipment 120 based on at least one of: a user voice recognized by the user equipment 120, a stored schedule arrangement of the user 130 (such as the schedule arrangement in a calendar), travel information (such as at least one of a short message of a train ticket reservation, or a short message of an air ticket reservation, a train ticket order, or an air ticket order). Therefore, the user equipment 120 may automatically determine the rental time.

The vehicle rental request, in some examples, may be transmitted to the server 160 by the user equipment 120 through the APP encrypting data hypertext transfer protocol secure (HTTPS). The server 160 may store the vehicle rental request in a database after receiving the vehicle rental request. Therefore, it's beneficial to improve information security of the vehicle rental request.

At block 204, the server 160 determines whether there exists a vehicle to-be-rented matched with the vehicle rental request at the pickup location (such as the parking lot of the building 174). For example, if the server 160 determines that there is the vehicle to-be-rented at the pickup location, the vehicle to-be-rented is determined as a rented vehicle. Thereafter, the server 160 determines whether the rented vehicle is in a ready state; if the server 160 determines that the rented vehicle is in the ready state, a response on the rented vehicle is generated to send to the user, and the response is indicative of the rented vehicle at the pickup location; if the server 160 determines that the rented vehicle is not in the ready state, a task of vehicle equipment is generated. The server 160 sends the task of vehicle equipment to an associated user 132 (a vehicle manager), so that the associated user 132 (the vehicle manager) gets the rented vehicle into the ready state.

If the server 160 determines that there is no vehicle to-be-rented matched with the vehicle rental request at the pickup location, at block 206, whether there exists a vehicle to-be-rented matched with the vehicle rental request at a rental outlet is determined, where the rental outlet is pre-selected by the user or determined based on a predetermined range from the pickup location. For example, the server 160 may automatically assign a rental outlet nearest to the pickup location, such as the rental outlet 170, based on the pickup location selected by the user 130. The user 130 may also preselect a vehicle rental outlet, and set manually the pickup location according to a location of the vehicle rental outlet and a route of the user 130. In some implementations, the server 160 may also automatically recommend a pickup location closest to the route of the user 130.

At block 208, if the server 160 determines that there is the vehicle to-be-rented at the rental outlet (such as the rental outlet 170), the vehicle to-be-rented at the rental outlet is determined as the rented vehicle, such as the vehicle 110.

At block 210, the server 160 sends a task of vehicle delivery to an electronic device associated with the rental outlet. The task is indicative of a location of the rented vehicle, the pickup location of the rented vehicle, and the rental time of the rented vehicle, such that the rented vehicle in the ready state (such as the vehicle 110) can be driven by the associated user 132 of the electronic device 122 to the pickup location (for example the parking lot of the building 174). The server 160 automatically assigns the task to the associated user 132 (the vehicle manager) of a determined rental outlet according to the determined rental outlet, and sends the task (such as the task of vehicle delivery and the task of vehicle equipment) to the electronic device 122 of the associated user 132 (the vehicle manager).

As mentioned above, the task of vehicle delivery indicated a pickup location and a location of the rented vehicle is sent to the electronic device associated with the rental outlet, by determining that there is no vehicle to-be-rented matched with the vehicle rental request at the pickup location indicated in the vehicle rental request of the user but a near rental outlet exists the vehicle to-be-rented matched with the vehicle rental request, such that the rented vehicle in the ready state can be driven by the associated user (such as the vehicle manager) of the electronic device to the pickup location. In the disclosure, the time and energy of the user in vehicle renting can be saved and the user can determine the pickup location.

In some implementations, the method 200 further includes the following. The server 160 sends information of a route to at least one of the pickup location, the location of the rented vehicle, and a return location, for the associated user 132 of the electronic device 122 to perform at least one of: arriving at the location (such as a parking lot of the building 172) of the rented vehicle (such as a vehicle 112); driving the rented vehicle in the ready state to the pickup location (such as the parking lot of the building 174); and driving a returned rented vehicle to the rental outlet (such as the rental outlet 170) or to a pickup location indicated by a next task of vehicle delivery. In some implementations, the information of a route to at least one of the pickup location, the location of the rented vehicle, and the return location is sent as follows. For example, if the server 160 determines that the rented vehicle is located at the rental outlet 170, the server 160 sends the information of a route from the rental outlet 170 to the pickup location, to enable the associated user to drive the rented vehicle in the ready state to the pickup location (such as the parking lot of the building 174). If the server 160 determines that the rented vehicle is not located at the rental outlet 170, the server 160 sends the information of a route from a location of the associated user 132 to the current location (such as the parking lot of the building 172) of the rented vehicle and the information of a route from the current location (such as the parking lot of the building 172) of the rented vehicle to the pickup location (such as the parking lot of the building 174), to enable the associated user 132 to arrive at the current location of the rented vehicle and drive the rented vehicle (such as the vehicle 110 or the vehicle 112) in the ready state to the pickup location (such as the parking lot of the building 174).

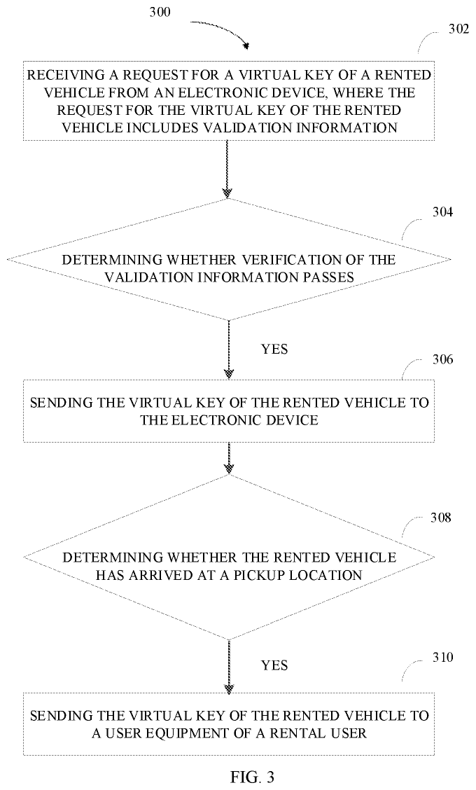

In some implementations, the method 200 further includes a method for sharing a virtual key of the vehicle. FIG. 3 is a schematic flow chart illustrating a method 300 for sharing the virtual key of the rented vehicle according to implementations of the disclosure. It should be understood that the method 300 may be performed by, for example, the electronic device 800 as shown in FIG. 8 or the server 160 as shown in FIG. 1. It should be understood that the method 300 may further include additional operations not shown and/or may omit operations shown, and the disclosure is not limited thereto.

At block 302, the server 160 receives a request for a virtual key of the rented vehicle (such as the vehicle 110) from the electronic device 122, where the request for the virtual key of the rented vehicle includes validation information. For example, in a process (such as a process of vehicle delivery or a process of vehicle pickup) of the associated user 132 (a vehicle manager) using the rented vehicle (such as the vehicle 110), for example, the associated user 132 may use an APP of the electronic device 122 to send the request to the server 160, to obtain the virtual key for controlling the rented vehicle (such as the vehicle 110).

At block 304, the server 160 determines whether verification of the validation information passes.

At block 306, the server 160 sends the virtual key of the rented vehicle (such as the vehicle 110) to the electronic device 122 if the server 160 determines that the verification of the validation information passes. For example, the electronic device 122 starts the vehicle 110 based on a Bluetooth virtual key assigned to the associated user 132 (the vehicle manager) by the server 160. For example, when the associated user 132 (the vehicle manager) goes to a surrounding area of the rented vehicle (such as the vehicle 110), the associated user 132 turns on the Bluetooth virtual key of the APP to establish a connection with the vehicle 110, such as a successful connection between the vehicle 110 and the electronic device 122 through a pairing secret key (e.g., the Bluetooth virtual key) assigned by the server 160, and thus the associated user 132 (the vehicle manager) can start the vehicle 110 by pressing one button after getting in the rented vehicle.

In some implementations, the electronic device 122 also may request the server 160 to send a token using for remotely controlling the vehicle, for example, the token is used for obtaining remotely state information of the vehicle 110. For example, the electronic device 122 of the associated user 132 (the vehicle manager) may send a control token and a control command to the server 160 by using the APP, and the server 160 further sends the control token and the control command to the vehicle 110, such that the associated user 132 implements control of the vehicle (such as remote control). In some implementations, control authority may include, for example, but not limited to, opening a vehicle door, closing the vehicle door, whistling, a double flashing, preheating the air conditioning, obtaining the state of the vehicle, and the like.

At block 308, the server 160 determines whether the rented vehicle has arrived at the pickup location. For example, the server 160 may determine whether the rented vehicle has arrived at the pickup location based on obtained GPS location information of the rented vehicle, or based on a message indicative of having arrived at the pickup location sent by the electronic device 122.

At block 310, the serve 160 sends the virtual key of the rented vehicle to the user equipment 120 of the rental user 130, if the serve 160 determines that the rented vehicle has arrived at the pickup location. The control authority of the virtual key may include, for example, but not limited to, starting the vehicle, opening the vehicle door, closing the vehicle door, whistling, the double flashing, preheating the air conditioning, obtaining the state of the vehicle, and the like. The server 160 may preset the control authority of the virtual key sent to the user 130.

Therefore, according to the disclosure, the virtual key of the rented vehicle can be automatically sent to the vehicle manager and the user renting the vehicle and there is no need for the vehicle manager and the user renting the vehicle to go back and forth to the rental outlet to pick up the vehicle key of the vehicle.

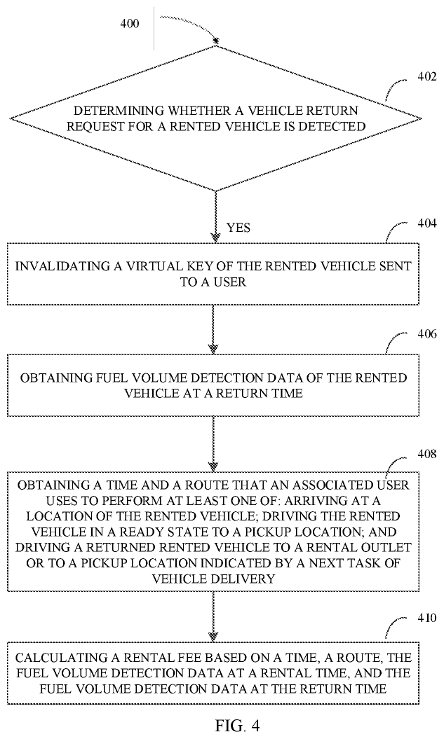

FIG. 4 is a schematic flow chart illustrating a method 400 for vehicle return according to implementations of the disclosure. It should be understood that the method 400 may be performed by for example the electronic device 800 as shown in FIG. 8 or the server 160 as shown in FIG. 1. It should be understood that the method 400 may further include additional operations not shown and/or may omit operations shown, and the disclosure is not limited thereto.

At block 402, the server 160 determines whether a vehicle return request for the rented vehicle is detected.

At block 404, if the server 160 determines that the vehicle return request for the rented vehicle is detected, the server 160 invalidates the virtual key of the rented vehicle sent to the user. Therefore, it's beneficial to protect safety of the rented vehicle and a next user renting the vehicle.

At block 406, the server 160 may obtain fuel volume detection data of the rented vehicle at a return time. The server 160 obtains the fuel volume detection data of the rented vehicle at the rental time if the server 160 determines that the rented vehicle has arrived at the pickup location. The fuel volume detection data may be detected by a fuel volume sensor of the vehicle and obtained by a communication module of the vehicle (such as a T-BOX).

At block 408, the server 160 obtains a time and a route that the associated user 132 uses to perform at least one of: arriving at a location of the rented vehicle; driving the rented vehicle in the ready state to the pickup location (such as the parking lot of the building 174); and driving a returned rented vehicle to the rental outlet (such as the rental outlet 170) or to a pickup location indicated by a next task of vehicle delivery.

At block 410, the server 160 calculates a rental fee based on the time, the route, the fuel volume detection data at the rental time, and the fuel volume detection data at the return time. In some examples, the above time includes the time spent in vehicle delivery (such as including vehicle equipment) and vehicle pickup by the associated user 132. The above route includes a mileage, obtained by driving route planning, of the associated user 132 for vehicle delivery, and a mileage, obtained by driving route planning, of the associated user 132 for returning to the rental outlet after vehicle pickup. In some examples, the rental fee includes a fee of vehicle delivery, a fee of vehicle rental of the user, a platform fee, and a fee of vehicle pickup. The calculation for the fee of vehicle delivery and a platform fee at a time of vehicle delivery is explained below in conjunction with the equations (1) and (2). The fee of vehicle delivery includes, for example, a delivery postage, a delivery labor fee, plus the platform fee at the time of vehicle delivery.

S=L*Y*P+((T+T2)*N+T3*N2) (1)

S1=S*1.2 (2)

In the above equations (1) and (2), L represents the mileage of vehicle delivery obtained by driving route planning. Y represents an amount of fuel consumed by the rented vehicle per kilometer (for example, in liters). P represents price per liter of 92 gasoline. T represents the time (for example, in hours) of vehicle delivery obtained by driving route planning. T2 represents a time (for example, in hours) that the associated user 132 (the vehicle manager) returns to the rental outlet 170 obtained by riding route planning after vehicle delivery. T3 represents a night shift time (for example, in hours). N represents a fee of manual unit time (for example, in hours) of the associated user 132 (the vehicle manager). N2 represents a fee of additional unit time (for example, in hours) of the associated user 132 (the vehicle manager) for night shift due to vehicle delivery. S represents the fee of the vehicle delivery. S1 represents the platform fee at the time of vehicle delivery.

The calculation for the fee of vehicle rental of the user is explained below in conjunction with the equation (3). The fee of vehicle rental of the user is, for example, equal to a fee of a vehicle rental time plus a fuel fee.

S2=(T4*N4)+(Y2−Y)*P (3)

In the above equation (3), S2 represents the fee of the vehicle rental of the user. T4 represents a time (for example, in minutes) that the user 130 uses the rented vehicle. N4 represents price per unit time (for example, in yuan/minute) that the user uses the rented vehicle. Y represents a fuel volume at a beginning of vehicle rental. Y2 represents a fuel volume at an end of vehicle rental. P represents the price of 92 gasoline (for example, in yuan/liter).

The calculation for the fee of the vehicle pickup is explained below in conjunction with the equations (4) and (5). The fee of the vehicle pickup is, for example, equal to the pickup postage, a labor fee, plus a platform fee at the time of vehicle pickup.

S3=L1*Y*P+((T5+T6)*N+T7*N2) (4)

S4=S3*1.2 (5)

In the above equations (4) and (5), S3 represents the fee of the vehicle pickup. S4 represents the platform fee. P represents the price of 92 gasoline (for example, in yuan/liter). Y represents a fuel volume consumed per kilometer by the rented vehicle. L1 represents the mileage, obtained by driving route planning, of returning to the rental outlet after vehicle pickup. T5 represents a time spent in vehicle pickup, obtained by riding route planning. T6 represents a time spent in returning to the rental outlet, that is the time, obtained by driving route planning, spent in returning to the rental outlet by the associated user 132 (the vehicle manager) after vehicle pickup. T7 represents night shift time due to the vehicle pickup. N represents the fee of the manual unit time (for example, in hours) of the associated user 132 (the vehicle manager). N2 represents the fee of the additional unit time (for example, in hours) for the night shift of the vehicle manager.

As mentioned above, the server 160 automatically assigns the task of vehicle delivery and the task of vehicle pickup to the vehicle manager of the rental outlet 170 to which the vehicle 110 belongs through scheduling in a system, and automatically calculates the fee of vehicle rental based on the location of the vehicle, a round-trip route, the mileage, the time, and a fuel consumption, as well as a fee of vehicle usage and the labor fee required for the vehicle manager to perform vehicle delivery and vehicle pickup. It is possible to save a time and energy of the user in vehicle delivery and vehicle pickup, and automatically and reasonably calculate a related fee of vehicle rental.

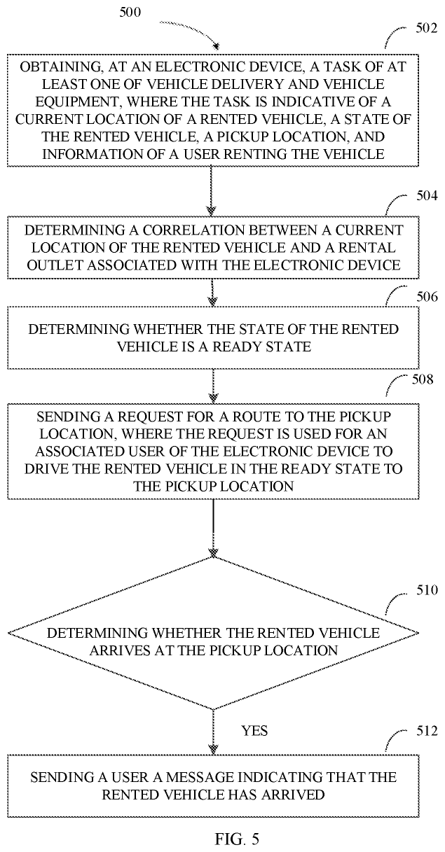

FIG. 5 is a schematic flow chart illustrating a method 500 for vehicle rental according to implementations of the disclosure. It should be understood that the method 500 may be performed by, for example, the electronic device 800 as shown in FIG. 8 or the electronic device 122 as shown in FIG. 1. It should be understood that the method 500 may further include additional operations not shown and/or may omit operations shown, and the disclosure is not limited thereto.

At block 502, an electronic device 122 obtains a task of at least one of vehicle delivery and vehicle equipment, where the task is indicative of a current location of a rented vehicle, a state of the rented vehicle, a pickup location, and information of a user renting the vehicle.

At block 504, the electronic device 122 determines a correlation between the current location of the rented vehicle and a rental outlet associated with the electronic device. For example, the electronic device 122 determines whether the rented vehicle is located at a rental outlet 170.

At block 506, the electronic device 122 determines whether the state of the rented vehicle is a ready state. For example, the electronic device 122 determines whether the rented vehicle is in the ready state in order to determine whether the rented vehicle need to be equipped at a time of vehicle delivery.

At block 508, the electronic device 122 sends (such as to a server 160) a request for a route to the pickup location, where the request is used for an associated user 132 of the electronic device 122 to drive the rented vehicle in the ready state to the pickup location (such as a parking lot of a building 174). The electronic device 122 sends the request for a route to the pickup location for example as follows. If the electronic device 122 determines that the rented vehicle is not located at the rental outlet 170, the electronic device 122 sends a request to the server 160, to obtain information of a route from a current location of the electronic device 122 to the current location (such as a parking lot of a building 172) of the rented vehicle and information of a route from the current location (such as the parking lot of the building 172) of the rented vehicle to the pickup location (such as the parking lot of the building 174), to enable the associated user 132 to arrive at the current location of the rented vehicle and drive the rented vehicle in the ready state to the pickup location (such as the parking lot of the building 174).

At block 510, the electronic device 122 determines whether the rented vehicle arrives at the pickup location (such as the parking lot of the building 174).

At block 512, the electronic device 122 sends a user 130 a message indicating that the rented vehicle has arrived if the electronic device 122 determines that the rented vehicle arrives at the pickup location.

In some implementations, the method 500 further includes the following. The electronic device 122 sends a request for a virtual key of the rented vehicle to the server 160, where the request for the virtual key of the rented vehicle includes validation information. The electronic device 122 receives the virtual key from the server 160. The electronic device 122 establishes a connection with the rented vehicle (such as the vehicle 110) based on the virtual key to control the rented vehicle, when determining that a distance from the electronic device to the rented vehicle is less than or equal to a preset distance. In some implementations, a control token and a control command are sent to the server, for the server to remotely control the rented vehicle.

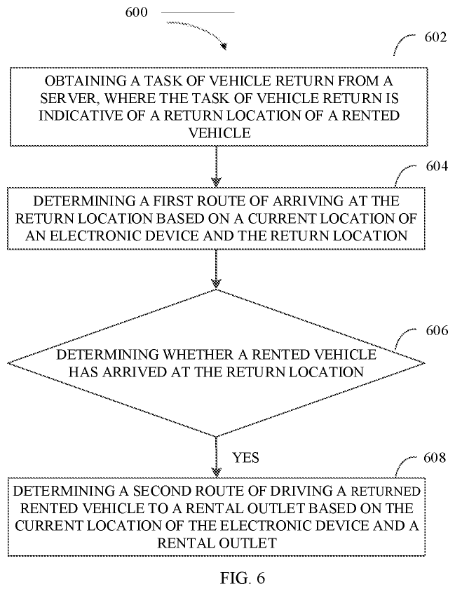

In some implementations, the method 500 further includes the method for vehicle pickup. FIG. 6 is a schematic flow chart illustrating a method 600 for vehicle pickup according to implementations of the disclosure. It should be understood that the method 600 may be performed by for example the electronic device 800 as shown in FIG. 8 or the electronic device 122 as shown in FIG. 1. It should be understood that the method 600 may further include additional operations not shown and/or may omit operations shown, and the disclosure is not limited thereto.

At block 602, a task of vehicle return is obtained from a server 160, where the task of vehicle return is indicative of a return location of the rented vehicle. For example, the server 160 may obtain a GPS coordinate at a return time of the vehicle 110 via a GPS module and a wireless communication module of the returned vehicle 110. In some implementations, the server 160 obtains the GPS coordinate of the vehicle 110 at predetermined intervals, or regularly receives and stores the GPS coordinate of the vehicle 110 sent by the wireless communication module of the vehicle 110. If the server 160 receives a request of vehicle return, the most recently obtained GPS coordinate of the vehicle 110 is sent to a vehicle manager associated with the determined rental outlet 170, such as the associated user 132. The associated user 132 for vehicle return may be the same as or different from the associated user 132 for vehicle pickup. An APP of the electronic device 122 of the associated user 132 may obtain GPS coordinate data of the vehicle 110 at the return time from the server 160 through encrypting HTTPS.

At block 604, a first route of arriving at the return location is determined based on the current location of the electronic device 122 and the return location. For example, the associated user 132 (the vehicle manager) obtains a GPS coordinate of the electronic device 122 via the APP, which takes the GPS coordinate of the electronic device 122 as a start point, takes a current GPS coordinate of the vehicle 110 as an end point, and determines the first route of riding (an electric bicycle) to the return location via a map engine integrated by the APP.

At block 606, the electronic device 122 determines whether the rented vehicle has arrived at the return location.

At block 608, a second route of driving the returned rented vehicle to the rental outlet is determined based on the current location of the electronic device 122 and the rental outlet if the electronic device 122 determines that the vehicle has arrived at the return location. For example, if the electronic device 122 determines that the associated user 132 (the vehicle manager) has arrived at the return location, the electronic device 122 takes the current GPS coordinate of the vehicle as a start point, takes a GPS coordinate of the determined rental outlet as an end point, and determines the second route of driving the rented vehicle to the rental outlet 170 via a map engine integrated by the APP, such that the rented vehicle will be driven from the return location to the determined rental outlet 170 for vehicle equipment and vehicle rental.

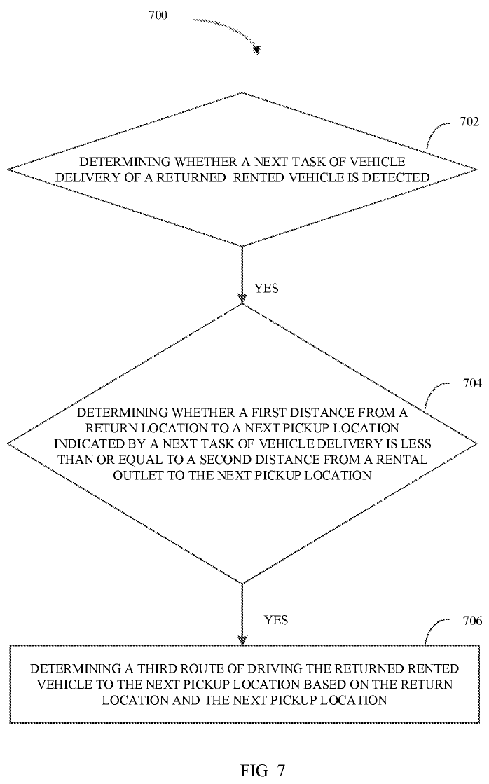

In some implementations, the method 700 further includes a method for vehicle pickup. FIG. 7 is a schematic flow chart illustrating a method 700 for vehicle pickup according to implementations of the disclosure. It should be understood that the method 700 may be performed by for example the electronic device 800 as shown in FIG. 8 or the electronic device 122 as shown in FIG. 1. It should be understood that the method 700 may further include additional operations not shown and/or may omit operations shown, and the disclosure is not limited thereto.

At block 702, the electronic device 122 determines whether a next task of vehicle delivery of the returned rented vehicle is detected.

At block 704, whether a first distance from the return location to a next pickup location indicated by the next task of vehicle delivery is less than or equal to a second distance from the rental outlet to the next pickup location is determined if the electronic device 122 determines that the next task of vehicle delivery of the returned rented vehicle is detected. For example, the electronic device 122 may determine whether a distance between the next pickup location and the return location of the last user 130 is smaller than a distance between the next pickup location and the rental outlet 170, if another user sends a new vehicle rental request after the user 130 returns the vehicle 110, and the returned vehicle 110, for example, is matched with the new vehicle rental request.

At block 706, a third route of driving the returned rented vehicle to the next pickup location is determined based on the return location and the next pickup location if the electronic device 122 determines that the first distance is less than or equal to the second distance. If the electronic device 122 may determine that the distance between the next pickup location and the return location of the last user is smaller than the distance between the next pickup location and the determined rental outlet, the associated user 132 (the vehicle manager) may directly go (such as riding) to the return location of the vehicle 110 to perform vehicle equipment and then directly drive the vehicle 110 to a pickup location of a next user.

Therefore, the disclosure may save a distance driven by the vehicle and a time spent in vehicle return and a renewal of vehicle rental.

FIG. 8 is a schematic block diagram illustrating an electronic device 800 suitable for implementing the implementations. The device 800 is configured to implement the methods 200 to 700 of the FIG. 2 to FIG. 7. As shown in FIG. 8, the device 800 includes a center processing unit (CPU) 801, which can perform various appropriate actions and processing according to computer program instructions which are stored in a read-only memory (ROM) 802 or loaded from a storage unit 808 to a random access memory (RAM) 803. In the RAM 803, various programs and data required for the operation of the device 800 can also be stored. The CPU 801, the ROM 802, and the RAM 803 are connected with each other through a bus 804. An input/output (I/O) interface 805 is also connected with the bus 804.

Multiple components in the device 800 are connected to the I/O interface 805, these components including: an input unit 806, an output unit 807, and a storage unit 808. The processing unit 801 performs various methods and processing described above, such as the methods 200 to 700. In some implementations, the methods 200 to 700 may be implemented as computer software programs, which are stored in a machine-readable medium, such as the storage unit 808. For example, in some implementations, part or all of the computer programs may be loaded and/or installed on the device 800 via the ROM 802 and/or the communication unit 809. When the computer programs are loaded into the RAM 803 and executed by the CPU 801, one or more actions of the methods 200 to 700 described above may be executed. Alternatively, in other implementations, the CPU 801 may be configured to perform one or more actions of the methods 200 to 700 via other any suitable methods (such as via the aid of firmware).

It should be further understood that, the present disclosure may be a method, device, system, and/or computer program product. The computer program product may include a computer-readable storage medium. The computer-readable storage medium stores computer-readable program instructions for executing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a wave guide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, devices (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create module for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be understood that, in some alternative implementations, the functions understood in the block may occur out of the order understood in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

The above is only an alternative embodiment of the disclosure and is not intended to limit the disclosure. For those skilled in the art, the disclosure may have various modifications and variations. Any modification, equivalent arrangements and improvement made within the spirit and principles of the disclosure shall be included in the scope of protection of the disclosure.

1. A method for vehicle rental, comprising:
receiving a vehicle rental request, wherein the vehicle rental request is at least indicative of a pickup location and a rental time of a user;
determining whether there exists a vehicle to-be-rented matched with the vehicle rental request at a rental outlet in response to determining that there is no vehicle to-be-rented matched with the vehicle rental request at the pickup location, wherein the rental outlet is pre-selected by the user or determined based on a predetermined range from the pickup location;
determining the vehicle to-be-rented at the rental outlet as a rented vehicle in response to determining that there is the vehicle to-be-rented at the rental outlet; and
sending a task of vehicle delivery to an electronic device associated with the rental outlet, wherein the task is indicative of a location of the rented vehicle, the pickup location, and the rental time, such that the rented vehicle in a ready state can be driven by an associated user of the electronic device to the pickup location.

2. The method of claim 1, further comprising:
determining a vehicle to-be-rented at the pickup location as the rented vehicle in response to determining that there is the vehicle to-be-rented at the pickup location;
determining whether the rented vehicle is in the ready state;
generating a response on the rented vehicle to send to the user in response to determining that the rented vehicle is in the ready state, wherein the response is indicative of the rented vehicle at the pickup location; and
generating a task of vehicle equipment in response to determining that the rented vehicle is not in the ready state.

3. The method of claim 1, further comprising:
sending information of a route to at least one of the pickup location, the location of the rented vehicle, and a return location to the associated user of the electronic device, for the associated user to perform at least one of:
arriving at the location of the rented vehicle;
driving the rented vehicle in the ready state to the pickup location; and
driving the returned rented vehicle to the rental outlet or to a pickup location indicated by a next task of vehicle delivery.

4. The method of claim 1, further comprising:
receiving a request for a virtual key of the rented vehicle from the electronic device, wherein the request for the virtual key of the rented vehicle comprises validation information;
sending the virtual key of the rented vehicle to the electronic device in response to determining that verification of the validation information passes; and
sending the virtual key of the rented vehicle to a user equipment of the user in response to determining that the rented vehicle has arrived at the pickup location.

5. The method of claim 1, further comprising:
obtaining fuel volume detection data of the rented vehicle at the rental time in response to determining that the rented vehicle has arrived at the pickup location.

6. The method of claim 4, further comprising:
invalidating the virtual key of the rented vehicle sent to the user in response to determining that a request of vehicle return for the vehicle rental is detected;
obtaining fuel volume detection data of the rented vehicle at a return time;
obtaining a time and a route that the associated user uses to perform at least one of:
arriving at the location of the rented vehicle;
driving the rented vehicle in the ready state to the pickup location; and
driving the returned rented vehicle to the rental outlet or to a pickup location indicated by a next task of vehicle delivery; and
calculating a rental fee based on the time, the route, the fuel volume detection data at the rental time, and the fuel volume detection data at the return time.

7. The method of claim 3, wherein sending the information of a route to at least one of the pickup location, the location of the rented vehicle, and the return location comprises:
sending the information of a route from the rental outlet to the pickup location in response to determining that the rented vehicle is located at the rental outlet, to enable the associated user to drive the rented vehicle in the ready state to the pickup location; and
sending information of a route from the associated user to a current location of the rented vehicle and information of a route from the current location of the rented vehicle to the pickup location, in response to determining that the rented vehicle is not located at the rental outlet, to enable the associated user to arrive at the current location of the rented vehicle and drive the rented vehicle in the ready state to the pickup location.

8. The method of claim 7, wherein the vehicle rental request is further indicative of a vehicle type, and the vehicle type is determined by the user or based on historical rental information of the user.

9. A method for vehicle rental, comprising:
obtaining, at an electronic device, a task of at least one of vehicle delivery and vehicle equipment, wherein the task is indicative of a current location of a rented vehicle, a state of the rented vehicle, a pickup location, and information of a user renting the vehicle;
determining a correlation between the current location of the rented vehicle and a rental outlet associated with the electronic device;
determining whether the state of the rented vehicle is a ready state;
sending a request for a route to the pickup location, wherein the request is used for an associated user of the electronic device to drive the rented vehicle in the ready state to the pickup location; and
sending to the user a message indicating that the rented vehicle has arrived in response to determining that the rented vehicle arrives at the pickup location.

10. The method of claim 9, wherein sending the request for a route to the pickup location further comprises:
sending a request to obtain information of a route from a current location of the electronic device to the current location of the rented vehicle and information of a route from the current location of the rented vehicle to the pickup location, in response to determining that the rented vehicle is not located at the rental outlet, to enable the associated user to arrive at the current location of the rented vehicle and drive the rented vehicle in the ready state to the pickup location.

11. The method of claim 9, further comprising:
sending a request for a virtual key of the rented vehicle to a server, wherein the request for the virtual key of the rented vehicle comprises validation information;
receiving the virtual key from the server; and
establishing a connection with the rented vehicle based on the virtual key to control the rented vehicle, in response to determining that a distance from the electronic device to the rented vehicle is less than or equal to a preset distance.

12. The method of claim 11, further comprising:
sending a control token and a control command to the server, for the server to remotely control the rented vehicle.

13. The method of claim 9, further comprising:
obtaining a task of vehicle return from a server, wherein the task of vehicle return is indicative of a return location of the rented vehicle;
determining a first route of arriving at the return location based on a current location of the electronic device and the return location;
determining whether the rented vehicle has arrived at the return location; and
determining a second route of driving the returned rented vehicle to the rental outlet based on the current location of the electronic device and the rental outlet, in response to determining that the vehicle has arrived at the return location.

14. The method of claim 13, further comprising:
determining whether a first distance from the return location to a next pickup location indicated by a next task of vehicle delivery is less than or equal to a second distance from the rental outlet to the next pickup location, in response to determining that the next task of vehicle delivery of the returned rented vehicle is detected; and
determining a third route of driving the returned rented vehicle to the next pickup location based on the return location and the next pickup location in response to determining that the first distance is less than or equal to the second distance.

15. The method of claim 11, wherein control authority of the virtual key of the rented vehicle comprises: starting/pulling off the rented vehicle, driving and controlling the rented vehicle, whistling, controlling an indicator light, opening/closing a vehicle door, and obtaining state information of the rented vehicle.

16. An electronic device, comprising:
a memory configured to store one or more computer programs; and
a processor coupled with the memory and configured to execute the one or more programs to cause the electronic device to:
receive a vehicle rental request, wherein the vehicle rental request is at least indicative of a pickup location and a rental time of a user;
determine whether there exists a vehicle to-be-rented matched with the vehicle rental request at a rental outlet in response to determining that there is no vehicle to-be-rented matched with the vehicle rental request at the pickup location, wherein the rental outlet is pre-selected by the user or determined based on a predetermined range from the pickup location;
determine the vehicle to-be-rented at the rental outlet as a rented vehicle in response to determining that there is the vehicle to-be-rented at the rental outlet and
send a task of vehicle delivery to an electronic device associated with the rental outlet, wherein the task is indicative of a location of the rented vehicle, the pickup location, and the rental time, such that the rented vehicle in a ready state can be driven by an associated user of the electronic device to the pickup location.

17. (canceled)

18. The electronic device of claim 16, wherein the processor is further configured to execute the one or more programs to cause the electronic device to:
determine a vehicle to-be-rented at the pickup location as the rented vehicle in response to determining that there is the vehicle to-be-rented at the pickup location;
determine whether the rented vehicle is in the ready state;
generate a response on the rented vehicle to send to the user in response to determining that the rented vehicle is in the ready state, wherein the response is indicative of the rented vehicle at the pickup location; and
generate a task of vehicle equipment in response to determining that the rented vehicle is not in the ready state.

19. The electronic device of claim 16, wherein the processor is further configured to execute the one or more programs to cause the electronic device to:
send information of a route to at least one of the pickup location, the location of the rented vehicle, and a return location to the associated user of the electronic device, for the associated user to perform at least one of:
arriving at the location of the rented vehicle;
driving the rented vehicle in the ready state to the pickup location; and
driving the returned rented vehicle to the rental outlet or to a pickup location indicated by a next task of vehicle delivery.

20. The electronic device of claim 16, wherein the processor is further configured to execute the one or more programs to cause the electronic device to:
receive a request for a virtual key of the rented vehicle from the electronic device, wherein the request for the virtual key of the rented vehicle comprises validation information;
send the virtual key of the rented vehicle to the electronic device in response to determining that verification of the validation information passes; and
send the virtual key of the rented vehicle to a user equipment of the user in response to determining that the rented vehicle has arrived at the pickup location.

21. The electronic device of claim 20, wherein the processor is further configured to execute the one or more programs to cause the electronic device to:
invalidate the virtual key of the rented vehicle sent to the user in response to determining that a request of vehicle return for the vehicle rental is detected;
obtain fuel volume detection data of the rented vehicle at a return time;
obtain a time and a route that the associated user uses to perform at least one of:
arriving at the location of the rented vehicle;
driving the rented vehicle in the ready state to the pickup location; and
driving the returned rented vehicle to the rental outlet or to a pickup location indicated by a next task of vehicle delivery; and
calculate a rental fee based on the time, the route, the fuel volume detection data at the rental time, and the fuel volume detection data at the return time.
